(19) United States
(12) Patent Application Publication
(10) Pub. No.: US 2025/0265046 A1
(43) Pub. Date: Aug. 21, 2025

(54) uLED DISPLAY DESIGN METHOD BASED ON NANOWIRE

(71) Applicant: FU ZHOU UNIVERSITY, Fuzhou, Fujian (CN)

(72) Inventors: Xing CHEN, Minhou Fuzhou (CN); Yi WANG, Minhou Fuzhou (CN); Zhenhao LI, Minhou Fuzhou (CN); Xiaona CHEN, Minhou Fuzhou (CN); Yan CHEN, Minhou Fuzhou (CN)

(73) Assignee: FU ZHOU UNIVERSITY, Fuzhou, Fujian (CN)

(21) Appl. No.: 17/788,327

(22) PCT Filed: Jul. 9, 2020
(86) PCT No.: PCT/CN2020/100966

§ 371 Date: Feb. 22, 2023

(30) Foreign Application Priority Data
Feb. 17, 2020 (CN) 202010096139.6

(51) Int. Cl. G06F 8/35

(52) U.S. Cl. CPC G06F 8/35

(57) ABSTRACT

The present invention relates to an automatic generation method for an Android application micro-service driven by an application scenario. The automatic generation method comprises the following steps: S1: reconstructing a software architecture when an application runs based on application interface information; S2: executing an objective function for many times, and recording the method calling sequence of the objective function to form calling instances of multiple objective function based on the runtime model; S3: analyzing the obtained calling instances to acquire a service module of the micro-service with the objective function; and S4: thereupon giving an user input, and executing the service module of the micro-service to obtain a result identical to the original function. The present invention is able to record the user calling sequences by monitoring all methods in an Android frame and an application, obtain a calling template of the micro-service by analyzing the multiple user calling sequences and reconstruct the software architecture when the application runs without sound codes and labels, so that automatic generation of the Android application micro-service is implemented.

### BACKGROUND OF THE INVENTION

### Technical Field

The present invention relates to the field of Android application micro-services, particularly to an automatic generation method for an Android application micro-service driven by an application scenario.

### Description of Related Art

In recent years, as mobile devices flourish, a lot of Android applications have emerged. These applications are inclusive of functions in all aspects, including life, health, travel and the like, and have become a main channel for people to use the Internet at mobile terminals. A single application with many functions may meet the demands of users of the application. However, it is more desirable that some functions of a plurality of applications are combined in use to meet the demand of personalized services, for example, calling a functional interface of application development by means of a mobile phone voice assistant. The precondition to achieve the goal lies in that the functions of the application are capable of providing external services or secondary development, which needs to be implemented by developers editing codes in development stage. With respect to functions which are not open in application development, after the application is issued, a user or a secondary developer of the application is unable to use them.

At present, by monitoring all methods in Android frame and application by using an Xposed frame, we are capable of obtaining types and methods executed by the application easily, so that the calling sequences for function execution are obtained. There is a problem to generate the micro-service through the calling sequences that in face of complicated applications, we are often unable to obtain a correct micro-service to implement corresponding functions if the calling sequences are not processed.

### BRIEF SUMMARY OF THE INVENTION

In view of this, the present invention is intended to provide an automatic generation method for an Android application micro-service driven by an application scenario, which may implement automatic generation of the Android application micro-service by reconstructing the software architecture when the application runs and recording the user calling sequences without sound codes and labels.

In order to achieve the above-mentioned purpose, the present invention adopts a technical solution as follows:
an automatic generation method for an Android application micro-service driven by an application scenario includes the following steps:
S1: reconstructing a software architecture when an application runs based on application interface information;
S2: executing an objective function for many times, and recording the method calling sequence of the objective function to form calling instances of multiple objective function based on the runtime model;
S3: analyzing the obtained calling instances to acquire a service module of the micro-service with the objective function;
S4: thereupon giving a user input, and executing the service module of the micro-service to obtain a result identical to the original function.

Further, the S2 specifically includes:
S21: creating event according to information of current method when detecting that a current method is a dispatchTouchEvent or setText method;
S22: calling the methods triggered by a current operation of a user, and adding them into InvokeTree of event;
S23: adding event into Events.

Further, the creating event according to information of current method in S21 specifically includes:
S211: calling a method of a caller object in method to acquire componentId and path; and
S212: respectively filling activityId, method and parameter of event with activityId, methodName and methodParameters of method.

Further, the S2 specifically includes:
S31: generating portions: activityId, componentId and path indicating that which component in which page simulates a user operation, wherein activityId indicates a user' page, componentId and path indicates components in the page; and
S32: generating InvokeTree, and solving a common subsequence of InvokeTree so as to obtain a series of methods that will be called by the application after simulating the operation of the user; and
) S33: generating portions: method and Parameters indicating which operation of the user will be simulated so as to obtain a service template corresponding to the micro-service.

Further, the step S32 specifically includes the following steps:
) S321: filling a data pool with data of a specific method in InvokeTree, wherein the specific method is a method and a sub-method thereof of a method caller for the component in the page, and the filling data is a call of the specific method and the sub-method thereof, a calling parameter and a called returned value;
S322: deleting a method call in InvokeTree according to the collected data;
S323: converting InvokeTree into character string sequences so as to obtain n character string calling sequences;
S324: finding out the shortest character string sequence, and sequentially checking whether character strings in the same positions in other character string sequences are identical based on the character string sequence, and if all the character strings in the same positions are identical, adding the character string into a final result till completely checking the character strings in all positions of the shortest character string sequence so as to obtain a final character string form of the public sub-sequence; and
S325: reversely parsing the final character string form of the public sub-sequence to an InvokeTree.

Further, the S33 specifically includes:
S331: dividing the operation into an input operation and a click operation;
S3332: with respect to the click operation, setting method to be dispatchTouchEvent, wherein Parameters represents a position of the current component in a screen, and its value is not needed to be acquired from Input and may be obtained directly by a method of calling a component object MotionEvent itself;
S333: with respect to the input operation, setting method to be setText, wherein Parameters represents input data of the user, Parameter is originated from input, and a sequence of inputting the parameter is identical to a sequence in the setText method; and
S334: therefore, traversing sequences in the template by an input type parameter algorithm, and replacing <T_i,V_i> in Parameters with <T_i, j> when it is the setText method, namely, the parameter of the method is data input by the j^{th} user to represent that Input is mapped with data in Parameters.

Further, the S2 specifically includes:
S41: instantiating Events of the service according to the user input; and
S42: executing the Events of the service template of the micro-service, wherein the page represented after executing all Events of the service template of the micro-service is Output of the micro-service.

Further, the S2 specifically includes:
S411: determining a specific value of Parameters according to a mapping relation between Input in h obtained API service template and Parameters in [symbol] Event [symbol] _i; and
S412: with respect to a specific user input [symbol] Input [symbol] \hat{ }′, when method in [symbol] Event [symbol] _i is setText, if a certain parameter in Parameters is <T_i, j>, assigning V_j of the j^{th}, data in [symbol] Input [symbol] \hat{ }′ to it, namely, the parameter in Parameters becomes a specific value <T_i, V_j>; and when method in [symbol] Event [symbol] _i is dispatchTouchEvent, stipulating that there is only one parameter in Parameters, and generating a MotionEvent object according to the position of a view component on the page corresponding to componentId and assigning a value to the parameter in Parameters.

Further, the S42 specifically includes:
S4421: setting that [symbol] Event [symbol] _i of each service is started from the first page of the application, namely, the page indicated by activityId of [symbol] Event [symbol] _1 is the first page of the application, and then sequentially executing Events;
S422: with respect to execution of each [symbol] Event [symbol] _i, first performing execution in the page indicated by activityId, then determining an object view for simulating the user operation in the interface according to componentId and path, and simulating the user operation by means of the setText method or the dispatchTouchEvent method;
S423: after simulating the user operation, monitoring the method call performed next by the application to obtain an ExecutionInvokeTree, and comparing it with the method in InvokeTree of the currently executed [symbol] Event [symbol] _i; and if the two formula are completely identical, considering that execution of current [symbol] Event [symbol] _i has been finished and executing a next [symbol] Event [symbol] _(i+1); and
S424: after executing all Events in the micro-service template, wherein the page represented by the application is Output of the micro-service.

Compared with the prior art, the present invention has the following beneficial effects:

The present invention is able to record the user calling sequences by monitoring all methods in an Android frame and an application, obtain a calling template of the micro-service by analyzing the multiple user calling sequences and reconstruct the software architecture when the application runs without sound codes and labels, so that automatic generation of the Android application micro-service is implemented.

### BRIEF DESCRIPTION OF THE SEVERAL VIEWS OF THE DRAWINGS

FIG. 1 is a schematic diagram of analysis and conversion processes from user operation to micro-service calling sequences in an embodiment of the present invention.

FIG. 2 is a process diagram of generating a service module and executing a service according to calling sequences in an embodiment of the present invention.

FIG. 3 is an algorithmic diagram of recording a user calling sequence in an embodiment of the present invention.

FIG. 4 is an algorithmic diagram of generating Event in an embodiment of the invention.

FIG. 5 is an algorithmic diagram of removing an irrelevant method call in an embodiment of the invention.

FIG. 6 is an algorithmic diagram of acquiring a common subsequence of InvokeTree in an embodiment of the present invention.

) FIG. 7 is an algorithmic diagram of executing a micro-service in an embodiment of the invention.

FIG. 8 is a micro-service interface of recording QQ music and searching for music in an embodiment of the present invention.

FIG. 9 is an input interface in an embodiment of the present invention.

FIG. 10 is an output interface in an embodiment of the present invention.

### DETAILED DESCRIPTION OF THE INVENTION

Further description of the present invention will be made below in combination with drawings and embodiments.

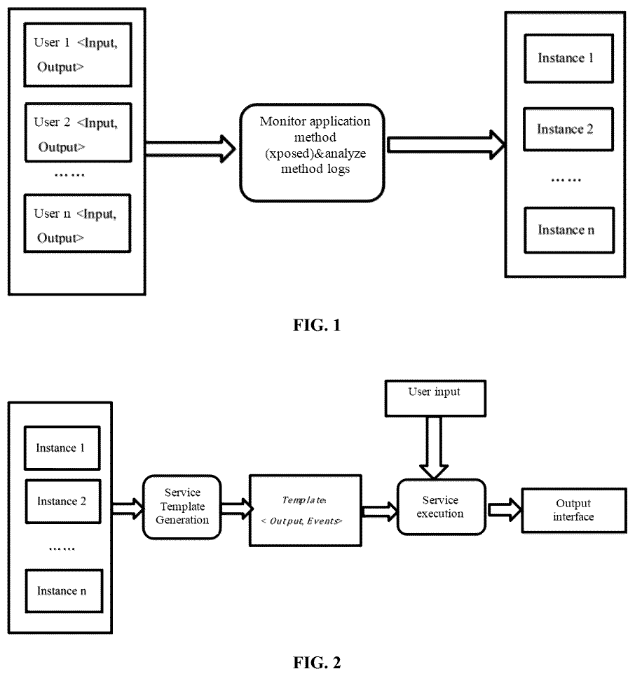

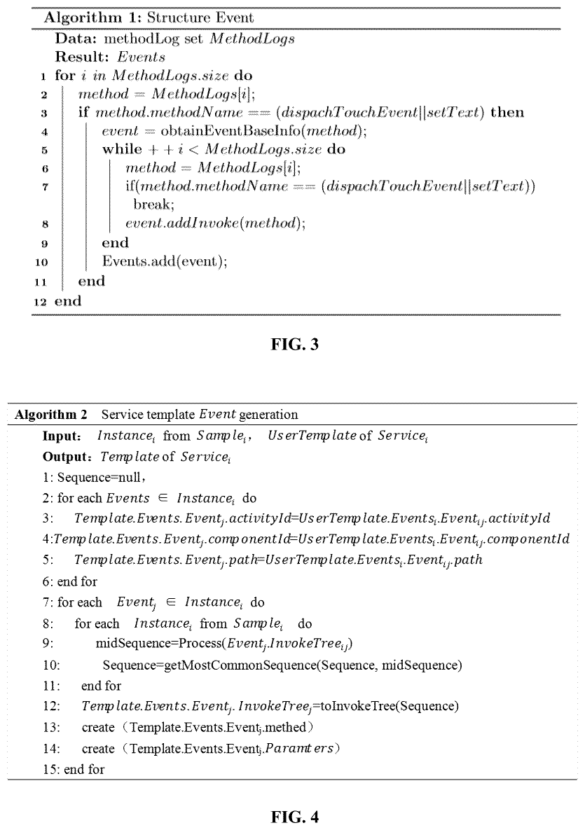

Referring to FIG. 1, the present invention provides an automatic generation method for an Android application micro-service driven by an application scenario, including the following steps:
S1: a software architecture is reconstructed when an application runs based on application interface information;
S2: an objective function is executed for many times, and a method calling sequence of the objective function is recorded to form calling instances of multiple objective function based on the runtime model;
S3: the obtained calling instances are analyzed to acquire a service module of the micro-service with the objective function; and
S4: thereupon a user input is given, and the service module of the micro-service is executed to obtain a result identical to the original function.

In the embodiment, an input set is Input={V_i1, V_i2 . . . V_in}. V_in represents the nth parameter value;
an output set is Output={activityId}, wherein activityId represents Id of the page;
a set of method call is Invoke=<Caller, Method, Args, Result>, wherein Caller represents a caller of the method, Method represents a calling method, Args represents all parameters transferred during method call,
Args
={ [symbol] arg [symbol] _1, [symbol] arg [symbol] _2 . . . [symbol] arg [symbol] _n}, wherein [symbol] arg [symbol] _l represent a certain parameter transferred during method call, and Result represents a returned value of method call.

A set of events is Events={ [symbol] Event [symbol] _1, [symbol] Event [symbol] _2, . . . [symbol] Event [symbol] _n}, wherein [symbol] Event [symbol] _i represents the i^{th} user operation [symbol] Event [symbol] _i={acivityId, componentId path, method, Parameters, InvokeTree}, wherein activityId represents the page of executing the operation, componentId represents ID of the component triggering the operation; path represents a path from a root node to the triggered operating node in a view; method represents a method that simulates the user operations, for example, inputting characters (setText) and clicking a screen (dispatchTouch); Parameters represents a parameter needed during execution, wherein Parameters={<T1, V1>,<T2, V2> . . . <Tn, Vn>}, for example, {<String, Ironman>} which may be acquired from Input InvokeTree represents a subsequent calling sequence of the application after the user executes the current operation.

InvokeTree={ [symbol] Invok [symbol] _1{ [symbol] Invoke [symbol] _1,1{ . . . }, [symbol] Invoke [symbol] _1,2{ . . . }, . . . }, [symbol] Invoke [symbol] _2{ . . . }, . . . };
a set of user calling sequences is Instance=<Input, Output Events>, wherein Input represents an input of the micro-service; Output represents an output result of the service, namely, the page represented by the service eventually; Events represents the user operation in the micro-service execution process.

A set of application calling logs is MethodLogs={ [symbol] method [symbol] _1, [symbol] method [symbol] _2, . . . [symbol] method [symbol] _n}, wherein [symbol] method [symbol] _i={ [symbol] caller [symbol] _i, [symbol] methodName [symbol] _i, [symbol] methodParameters [symbol] _i, [symbol] activityId [symbol] _i, [symbol] methodchilds [symbol] _i}, [symbol] caller [symbol] _i represents a caller of the method; [symbol] methodName [symbol] _i represents a name of the method, [symbol] methodParameters [symbol] _i={<P_1,V_1>, <P_2,V_2> . . . <P_n,V_n>}, wherein P_i represents a type of the i^{th}, parameter, V_i represents a value of the i^{th} parameter, [symbol] activityId [symbol] _i represents Id of the page called by the method, [symbol] methodChilds [symbol] _i represents a set of other methods called in the method, [symbol] methodChilds [symbol] _i={ [symbol] method [symbol] _i1, [symbol] method [symbol] _i2 . . . [symbol] method [symbol] _i}.

A set of micro-service service modules is Template=<Output Events> wherein Output represents the output result of the service, and Events represents the user operation in the micro-service execution process.

In the embodiment, with respect to one user calling sequence, Input and Output may be directly acquired because they are given by the user. Events of the calling sequence may be obtained by analyzing the calling log of the application. The calling log may be acquired by monitoring all methods in the Android frame and applications. Event is acquired through an algorithm shown in FIG. 3:

Traversal is performed continuously to check method call in MethodLogs, Events is acquired in three steps, and the algorithm is as shown in FIG. 3:

S1: event (Lines 3-4) is created according to information of method.

event is created according to information of current method when detecting that a current method is a dispatchTouchEvent or setText method. Specifically, the method of calling the caller object in method acquires componentId and path, and activityId method and parameter of event are respectively filled with activityId, methodName and methodParameters of method.

S2: InvokeTree (Lines 5-8) of event is generated.

With respect to a next method and a method prior to the next dispatchTouchEvent or setText method, it is considered that they are method call triggered by current operation of the user and they are added into InvokeTree of event.

S3: event is added into Events (Line 10).

After the above-mentioned two steps, a formalized representation of a user operation is generated, namely, event, and the event is added into Events.

With respect to a user operation, a method calling log is generated, and formalized representation, namely, Events, of the user operation in the process may be obtained by means of the above-mentioned method. In addition to Input and Output given by the user, recording of a user calling sequence corresponding to the service is completed.

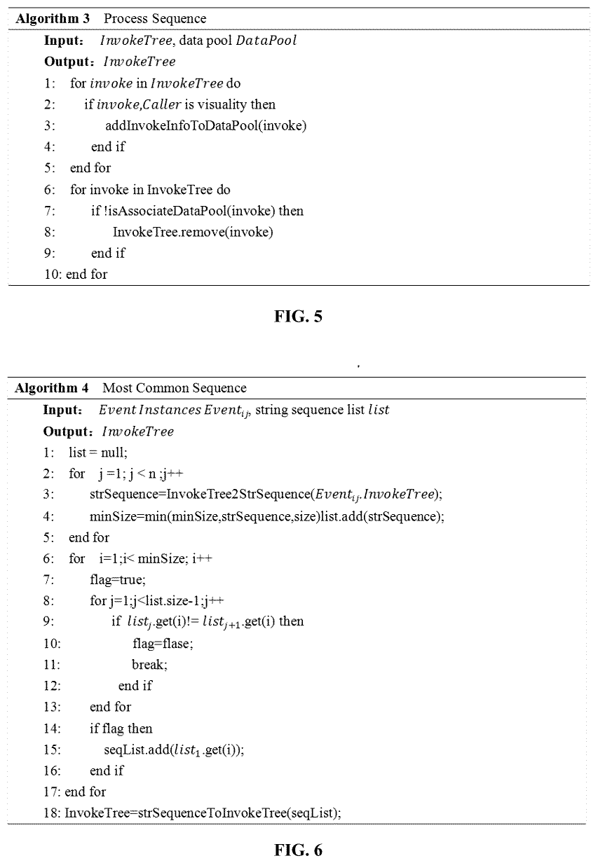

In the embodiment, in the service template, Output is the page obtained by executing all Event in the template completely. Therefore, it is only needed to generate each [symbol] Event [symbol] _i of the service template. By analyzing the multiple user calling sequences that execute the same micro-service, the service template of the service may be obtained. The algorithm that generates Event is as shown in FIG. 4:
the multiple instances are analyzed to generate Event of the service template of the service, and Event of the service template is generated through three steps, the algorithm being as shown in FIG. 4:

S1: a portion (Lines 2-6) of activityId, componentId and path is generated:
this portion indicates which component in which page is used to simulate the user operation. activityId indicates a user' page, and componentId and path indicates components in the page. At the same time, it is assumed that the user's operation is immobilized when using a certain service. Therefore, with respect to the multiple instances of this service, the quantities of Event are identical, and three elements activityId, componentId and path of [symbol] Event [symbol] _i (for example, the i^{th} [symbol] Event [symbol] _i) in same position are identical. Thus, it is only needed to place the three elements in [symbol] Event [symbol] _i of one instance in the corresponding positions of the template. These elements may be obtained from the log.

S2: a portion (Lines 7-11) of InvokeTree is generated:
this portion illustrates a series of methods that will be called by the application after simulating the user operation. Whether the current operation is completed is detected and whether a next operation may be performed just by monitoring the method call in the portion. Generation of InvokeTree is completed through two steps. S1: InvokeTree is pre-processed. The application will usually perform a series of method calls to respond to the user operation. After the user operation, a part of these method calls occurring in the application is irrelevant to the user operation. Then this part of irrelevant method calls will be removed according to transmissibility of data. S2: the common sub-sequence of InvokeTree is acquired. In this step, the common sub-sequence of InvokeTree is solved according to a thought of the character string common sub-sequence.

S3: a portion (Lines 13-14) of method and Parameters is generated:
this portion indicates which operation of the user is to be simulated. Since the user operation is substantially an input operation or a click operation (a sliding operation may be regarded as continuous click operations), the operation will also be divided into input operation and click operation. With respect to the click operation, method is set to be dispatchTouchEvent, wherein Parameters represents a position of the current component in a screen, and its value is not needed to be acquired from Input and may be obtained directly by a method of calling a component object MotionEvent itself. With respect to the input operation, method is set to be setText, wherein Parameters represents input data of the user. Parameter is only originated from input, and a sequence of inputting the parameter is identical to a sequence in the setText method. Therefore, sequences in the template will be traversed by an input type parameter algorithm, and replacing <T_i,V_i> in Parameters with <T_i,j> when it is the setText method, namely, the parameter of the method is data input by the j^{th} user to represent that Input is mapped with data in Parameters.

This portion InvokeTree of Event of the service template is generated through two steps. First of all, this part of irrelevant method calls will be removed according to transmissibility of data, and then the common sub-sequence of InvokeTree is solved.

First portion: the irrelevant method calls are removed through the algorithm shown in FIG. 5 to pre-process InvokeTree.

InvokeTree is pre-processed through two steps, the algorithm being shown in FIG. 5:

First, data (Lines 1-5) in the data pool is initialized.

A data pool is filled with data of a specific method in InvokeTree, wherein the specific method is a method and a sub-method thereof of a method caller for the component in the page. The filling data is a call of the specific method and the sub-method thereof, a calling parameter and a called returned value. As these data may be associated with the content on the page and change of these data may cause change of the content on the page, these data are selected as a ground of an identification method, namely, as long as these data are not involved in the method, it may be considered that this is a method of insignificance, which may be removed.

second, a method call (lines 6-10) in InvokeTree is deleted according to the collected data.

If the caller, the calling parameter or the called returned value of a certain method call (including a sub-method call thereof) in InvokeTree do not exist in the previous data pool, this method call will be deleted.

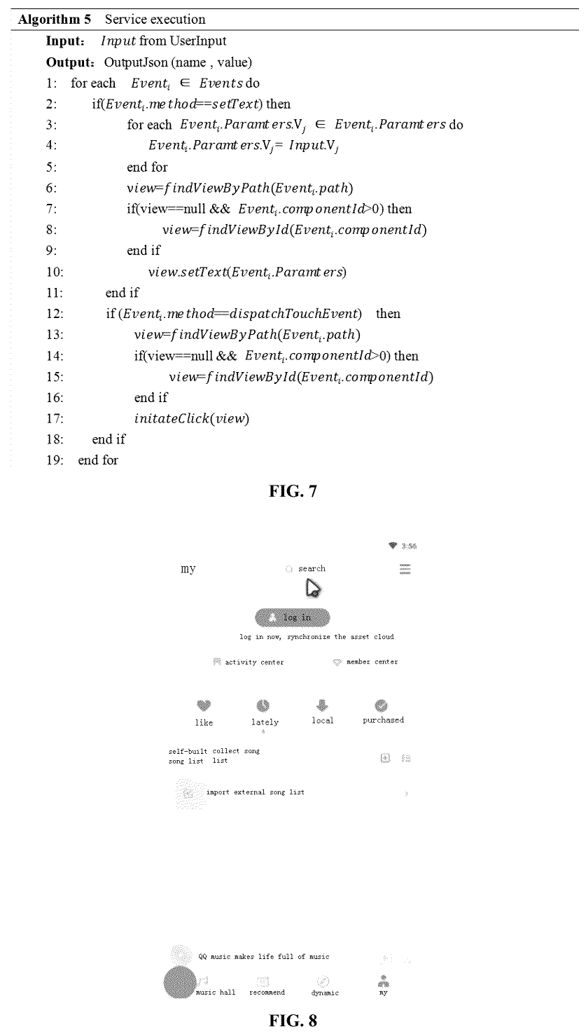

Second portion: the common sub-sequence of InvokeTree is obtained through the algorithm shown in FIG. 6:
the common sub-sequence of InvokeTree is obtained through three steps, the algorithm being shown in FIG. 6:

S1: InvokeTree is converted into a character string sequence (lines 2-5).

One InvokeTree is constituted by multiple Invoke trees. Here, preorder traversal is performed on each tree. When nodes of the tree are traversed, a type name of the caller and a method name of the method and a type name corresponding to the parameter in the method are extracted, they are spliced to one character string, and the obtained character strings are spliced to a new character string according to a preorder traversal sequence. Thus, after traversal is completed, the character string represents the invoke tree. Then each invoke tree in InvokeTree is converted into one character string according to the method, so as to obtain the corresponding character string sequence of InvokeTree.

S2: the common sub-sequence (6-17) of n character string calling sequences is obtained.

Multiple InvokeTree instances are converted into character string sequences according to the method in S1 so as to obtain n character string calling sequences. The shortest character string sequence is found out first, and whether character strings in the same positions in other character string sequences are identical is sequentially checked based on the character string sequence, and if all the character strings in the same positions are identical, the character string is added into a final result till the character strings in all positions of the shortest character string sequence are completely checked so as to obtain a final character string form of the public sub-sequence.

S3: the sequence is reversely parsed into one InvokeTree (line 18).

After the maximum common sub-sequence is obtained, the sequence is reversely parsed into one InvokeTree and the InvokeTree is the maximum common sub-sequence of the multiple InvokeTree instances. Therefore, InvokeTree of Event is obtained.

Thus, the service template of the corresponding micro-service is obtained according to the above-mentioned steps.

In the embodiment, the user operation is simulated to execute the corresponding service. Each user operation started from opening the application is recorded as one [symbol] Event [symbol] _i in the service, so that what we have to do is to execute these [symbol] Event [symbol] _i sequentially. The micro-service is executed through the following algorithm: the service is executed in two portions. The algorithm is as shown in FIG. 7:

S1: Events (lines 2-18) of the service are instantiated by using user input.

A specific value of Parameters is determined according to a mapping relation between Input in the previously obtained API service template and Parameters in [symbol] Event [symbol] _i. With respect to a specific user input [symbol] Input [symbol] \hat{ }i, when method in [symbol] Event [symbol] _i is setText, if a certain parameter in Parameters is <T_i, j>, V_J of the J^{th} data in [symbol] Input [symbol] \hat{ }i is assigned to it, namely, the parameter in Parameters becomes a specific value <T_i, V_j>, and when method in [symbol] Event [symbol] _i is dispatchTouchEvent, it is stipulated that there is only one parameter in Parameters, and a MotionEvent object is generated according to the position of a view component on the page corresponding to componentId and a value is assigned to the parameter in Parameters.

S2: Events (Lines 10 and 17) of the service are executed.

It is stipulated that [symbol] Event [symbol] _i of each service is started from the first page of the application, namely, the page indicated by a activityId of [symbol] Event [symbol] _1 is the first page of the application, and then Events is sequentially executed.

With respect to execution of each [symbol] Event [symbol] _i, first execution is performed in the page indicated by activityId. An object view for simulating the user operation in the interface is then determined according to componentId and path and the user operation is simulated by means of the setText method or the dispatchTouchEvent method.

After the user operation is simulated, the method call performed next by the application is monitored to obtain an ExecutionInvokeTree, and it is compared with the method in InvokeTree of the currently executed [symbol] Event [symbol] _i; and if the two formulae are completely identical, it is considered that execution of current has been finished and executing a next. If the two InvokeTree are completely identical, it is considered that execution of the current [symbol] Event [symbol] _i has been finished, and a next [symbol] Event [symbol] _(i+1) may be executed.

After all Events in the micro-service template are executed, wherein the page represented by the application is Output of the micro-service.

In the embodiment, it is divided into two portions: recording the user calling sequences and generating the micro-service based on development of java language, Android Studio and an Eclipse platform. When the user calling sequences are recorded, source codes of a recording related technique are imported into a working range of the Android Studio, corresponding modules are generated and activated on the Android platform installed with xposed, then the first page of the application needed to record the micro-service is opened, a round button region on the bottom left side is clicked, and corresponding operations are executed according to function steps. After all operations are executed completely, the round button region is clicked again to finish the recording, thereby completing recording of one user calling sequence. A recording result is stored in a methodLog.txt file under storage/emulated/0. FIG. 8 is an interface of a micro-service of recording QQ music and searching for music in an embodiment of the present invention.

After the multiple user calling sequences are recorded successfully, the micro-service may be generated according to the calling sequences. The source codes of the related technique that analyzes the sequences are imported into a working range of Eclipse, a position of txt that stores the user calling sequences is given after the 30th line of StartBuildModel.java is found out, then a java file is run to enter an analyzing stage, and after a control console outputs the file, the obtained result is stored in the txt file and placed under storagelemulated/0 of a mobile phone; and then the source codes of the micro-service generating related technique are imported into the working range of the Android Studio, the file name of txt filled with the stored result on the 45th line of MethodTrackPool.java is found out, and the program is run to generate the corresponding micro-service.

In the embodiment, verification tests on generation of micro-services for totally 13 functions of 9 applications such as Douban Movie and QQ Music, wherein 11 of them are verified correct. A verification result is as shown in a table 1:

TABLE 1
Verification result

| | Verify the quantity | Verify the quantity of |
|---|---|---|
| APP | of micro-services | correct micro-services |
| CUCO | 1 | 1 |
| DIANLAIKE business | 2 | 1 |
| cashier software | | |
| Douban Movie | 2 | 1 |
| Eudic | 1 | 1 |
| QQy Music | 2 | 2 |
| Complete book of cookery | 2 | 2 |
| TimberX | 1 | 1 |
| Palmtop part-time job | 1 | 1 |
| Anki | 1 | 1 |
| Aggregate | 13 | 11 |

It may be known from the above table that the available rate of the generated micro-services is about 84%. The reason why the generated micro-services are unavailable is that as execution of the micro-services is dependent on monitoring the methods in the APP, the generated micro-services are defective when there are no methods of the APP monitored, so that it makes mistakes in executing the micro-services.

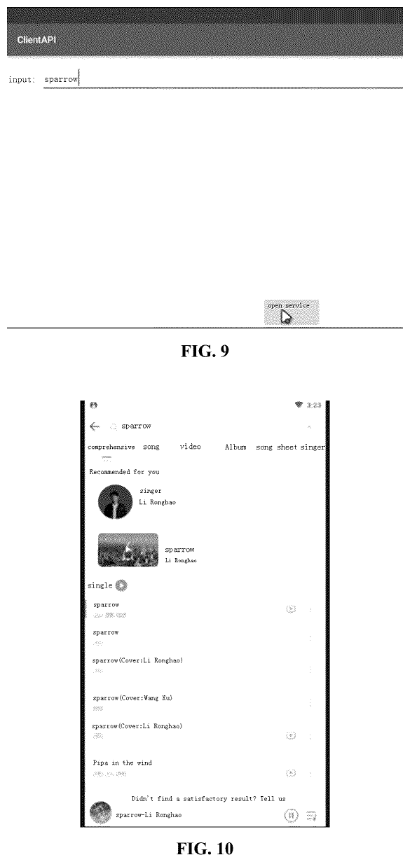

The user calling sequences are analyzed and recorded, and each user operation Event is recorded, so that the micro-service template is generated. Each Event in the template is executed again to implement execution of the micro-service when the micro-service is executed, and therefore, when the recorded user calling sequence is intact, the Event in the micro-service template analyzed is called again to implement the corresponding micro-service. Micro-service input and output interfaces for searching function of QQ Music are shown in FIG. 9 and FIG. 10.

According to the above-mentioned verification result and the input and output interfaces, we may find that a result obtained a searching sparrow of a generated music searching micro-service is identical to the finally obtained page when we search for music normally. Meanwhile, under a majority of circumstances, we may generate correct micro-services by analyzing the multiple user sequences, indicating that the effectiveness and accuracy of the method may be met.

The above is merely the preferred embodiments of the present invention, and equivalent changes and modifications made within the scope of the patent applied by the present invention shall fall into the scope of the present invention.

What is claimed is:

1. An automatic generation method for an Android application micro-service driven by an application scenario, comprising the following steps:
S1: reconstructing a software architecture when an application runs based on application interface information;
S2: executing an objective function for many times, and recording the method calling sequence of the objective function to form calling instances of multiple objective function based on the runtime model;
S3: analyzing the obtained calling instances to acquire a service module of the micro-service with the objective function; and
S4: thereupon giving a user input, and executing the service module of the micro-service to obtain a result identical to the original function.

2. The automatic generation method for an Android application micro-service driven by an application scenario according to claim 1, wherein the S2 specifically comprises:
S21: creating event according to information of current method when detecting that a current method is a dispatchTouchEvent or setText method;
S22: calling the methods triggered by a current operation of a user, and adding them into InvokeTree of event; and
S23: adding event into Events.

3. The automatic generation method for an Android application micro-service driven by an application scenario according to claim 2, wherein creating event according to information of current method in S21 specifically comprises:
S211: calling a method of a caller object in method to acquire componentId and path; and
S212: respectively filling activityId, method and parameter of event with activityId, methodName and methodParameters of method.

4. The automatic generation method for an Android application micro-service driven by an application scenario according to claim 1, wherein the S3 specifically comprises:
S31: generating portions: activityId, componentId and path, indicating that which component in which page simulates a user operation, wherein activityId indicates a user' page, componentId and path indicates components in the page, and
S32: generating InvokeTree, and solving a common subsequence of InvokeTree so as to obtain a series of methods that will be called by the application after simulating the operation of the user; and
S33: generating portions: method and Parameters indicating which operation of the user will be simulated so as to obtain a service template corresponding to the micro-service.

5. The automatic generation method for an Android application micro-service driven by an application scenario according to claim 1, wherein the S32 specifically comprises the following steps:
S321: filling a data pool with data of a specific method in InvokeTree, wherein the specific method is a method and a sub-method thereof of a method caller for the component in the page, and the filling data is a call of the specific method and the sub-method thereof, a calling parameter and a called returned value;
S322: deleting a method call in InvokeTree according to the collected data;
S323: converting InvokeTree into character string sequences so as to obtain n character string calling sequences;
S324: finding out the shortest character string sequence, and sequentially checking whether character strings in the same positions in other character string sequences are identical based on the character string sequence, and if all the character strings in the same positions are identical, adding the character string into a final result till completely checking the character strings in all positions of the shortest character string sequence so as to obtain a final character string form of the public sub-sequence; and
S325: reversely parsing the final character string form of the public sub-sequence to an InvokeTree.

6. The automatic generation method for an Android application micro-service driven by an application scenario according to claim 1, wherein the S33 specifically comprises:
S331: dividing the operation into an input operation and a click operation;
S332: with respect to the click operation, setting method to be dispatchTouchEvent, wherein Parameters represents a position of the current component in a screen, and its value is not needed to be acquired from Input and may be obtained directly by a method of calling a component object MotionEvent itself;
S333: with respect to the input operation, setting method to be setText, wherein Parameters represents input data of the user, Parameter is originated from input, and a sequence of inputting the parameter is identical to a sequence in the setText method; and
S334: therefore, traversing sequences in the template by an input type parameter algorithm, and replacing <Tᵢ, Vᵢ> in parameters with <Tᵢ, j> when it is the setText method, namely, the parameter of the method is data input by the j^{th} user to represent that Input is mapped with data in Parameters.

7. The automatic generation method for an Android application micro-service driven by an application scenario according to claim 1, wherein the S4 specifically comprises:
S41: instantiating Events of the service according to the user input; and
S42: executing the Events of the service template of the micro-service, wherein the page represented after executing all Events of the service template of the micro-service is Output of the micro-service.

8. The automatic generation method for an Android application micro-service driven by an application scenario according to claim 7, wherein the S41 specifically comprises:
S411: determining a specific value of Parameters according to a mapping relation between Input in the previously obtained API service template and Parameters in Eventᵢ; and
S412: with respect to a specific user input Input′, when method in Eventᵢ is setText, if a certain parameter in Parameters is <Tᵢ, j>, assigning Vᵢ of the j^{th} data in Input′ to it, namely, the parameter in Parameters becomes a specific value <Tᵢ,Vⱼ>; and when method in Event, is dispatchTouchEvent, stipulating that there is only one parameter in Parameters, and generating a MotionEvent object according to the position of a view component on the page corresponding to componentId and assigning a value to the parameter in Parameters.

9. The automatic generation method for an Android application micro-service driven by an application scenario according to claim 7, wherein the S42 specifically comprises:
S4421: setting that Eventᵢ of each service is started from the first page of the application, namely, the page indicated by activityId of Eventᵢ is the first page of the application, and then sequentially executing Events;
S422: with respect to execution of each Eventᵢ, first performing execution in the page indicated by activityId, then determining an object view for simulating the user operation in the interface according to componentId and path, and simulating the user operation by means of the setText method or the dispatchTouchEvent method;
S423: after simulating the user operation, monitoring the method call performed next by the application to obtain an ExecutionInvokeTree, and comparing it with the method in InvokeTree of the currently executed Eventᵢ; and if the two formula are completely identical, considering that execution of current Eventᵢ has been finished and executing a next Eventᵢ₊₁; and
S424: after executing all Events in the micro-service template, wherein the page represented by the application is Output of the micro-service.
